(19) United States
(12) Patent Application Publication
(10) Pub. No.: US 2007/0040353 A1
(43) Pub. Date: Feb. 22, 2007

(54) Off-road dolly for displacement of a trailer in an off-road environment

(76) Inventors: Jolain Dallaire, St-Jean Chrysostome (CA); Michel Gosselin, Beauport (CA)

Correspondence Address: Franz BONSANG;c/o PROTECTIONS EQUINOX INT'L INC., Suite 224, 4480, Cote-de-Liesse, Montreal, QC, H4N 2R1, CA

(21) Appl. No.: 11/204,018

(22) Filed: Aug. 16, 2005

(51) Int. Cl. B62D 53/08

(52) U.S. Cl. 280/476.1

(57) ABSTRACT

An off-road dolly has a pneumatic system for providing compressed air to trailer brakes and dolly brakes means for providing synchronized engagement thereof. Off-road dolly also has an electrical circuit providing synchronized engagement of dolly signal lighting system with trailer signal lighting system. Propulsion for off-road dolly and trailer can be provided externally, using a forklift, or by the off-road dolly itself using a motor installed thereon. Synchronized operational engagement of dolly brakes with trailer brakes, and dolly signal lighting system with trailer signal lighting system, can be controlled using a remote control.

### FIELD OF THE INVENTION

The present invention concerns dollys for displacing trailers connected thereto, and more specifically to an off-road dolly for displacement of trailers in an off-road environment.

### BACKGROUND OF THE INVENTION

Off-road displacement of a trailer in an off-road environment, such as a factory, often requires connection of the trailer to an off-road dolly designed for hauling the trailer in such an environment. The off-road dolly is in turn operatively connected to a propulsion means for providing a propulsion force for moving the trailer.

Dollys are well known in the art. For example, U.S. Pat. No. 5,284,356 discloses a dolly having a fifth wheel assembly thereon for connecting the dolly thereto. The dolly can be connected to the tractor by means of a three point hitch. The fifth wheel assembly of the dolly includes a fifth wheel plate adapted to retentively engage the king pin of the over-the-road trailer. However, such dollys are typically designed to work with larger propulsion means, such as a tractor, which may be too large or cumbersome to allow comfortable maneuvering of the trailer in an off-road environment and thus are inappropriate for use as off-road dollys.

To address the problem of the size of the propulsion means, some off-road dollys have built in propulsion means incorporated as a part of the dolly. Thus, the off-road dolly is operatively connected to the propulsion means as an internal part of the dolly, thereby reducing space required for the propulsion means and for maneuvering the trailer with the off-road dolly during displacement of the trailer. For example, U.S. Pat. No. 5,139,102 discloses a compact steerable off-road dolly for moving a trailer in off-road environments such as a work area. The off-road dolly includes an engine as the propulsion means for driving at least one of wheels of the dolly and a steering mechanism for turning a steerable wheel or wheels thereof. However, while this off-road dolly does provide for maneuvering in smaller off-road environments it does not provide for operative engagement of trailer braking means for braking the trailer, which may make such braking difficult.

U.S. Pat. No. 4,629,020 discloses a compact steerable off-road dolly which also has an engine incorporated therein for providing propulsion of the trailer and off-road dolly. In addition, the off-road dolly also includes a pneumatic system driven by the engine for providing compressed air for releasing a trailer braking means on the trailer for enabling motion thereof, the trailer braking means being operatively engaged when the air flow is terminated. However, it does not provide for selective synchronized engagement of a propulsion braking means of the propulsion means with engagement of the trailer braking means, thus making braking of the propulsion means and trailer together cumbersome. In addition, these dollys do not provide for synchronization of propulsion means signal lighting systems for indicating when propulsion braking means on propulsion means are engaged or directions of the propulsion motion of the propulsion means, such as when the propulsion means is turning, with trailer signal lighting systems providing similar functions for the trailer. Further, when propulsion means is situated on the off-road dolly, these systems do not provide synchronized operative engagement of dolly braking means on the dolly, for braking propulsion motion thereof or for indicating direction of the propulsion motion, with either the trailer signal lighting system and the propulsion means lighting system for indicating similar actions by the trailer or propulsion means. This lack of synchronized signaling capability and synchronized operational engagement of propulsion braking means, trailer braking means, and, when applicable, dolly braking means may render braking and changes in direction, such as turning, when displacing a trailer with the off-road dolly both difficult and hazardous.

In the light of the foregoing, it would be advantageous to provide an off-road dolly connectable to a propulsion means that is suitable for use in an off-road environment and that has improved control of braking means for the trailer, the propulsion means, and, when the propulsion means is not situated on the off-road dolly, the off-road dolly itself. It would also be useful to provide on off-road dolly having enhanced control of trailer signal lighting system, propulsion means lighting systems, and when the propulsion means is not situated on the off-road dolly, dolly signal lighting systems for the off-road dolly itself.

### SUMMARY OF THE INVENTION

It is a general object of the present invention to provide an off-road dolly having improved control of braking means for the trailer, of the propulsion means, and of the off-road dolly itself.

An advantage of the present invention is that the off-road dolly provides synchronized braking of trailer, propulsion means, and off-road dolly.

It is a further advantage of the present invention that the off-road dolly provides synchronization of trailer signal lighting system, dolly lighting system, and propulsion means lighting system.

In one aspect, the present invention provides an off-road dolly for connecting to a propulsion means for off-road displacement of a trailer. The propulsion means drives a propulsion motion of the off-road dolly and a corresponding trailer motion of the trailer and the trailer has a trailer braking means for providing trailer braking of the trailer motion. The off-road dolly comprises a trailer connecting means for connecting the trailer to the dolly, a pneumatic system, and a remote control means. The pneumatic system is connectable to the trailer braking means for providing compressed air for operatively engaging the trailer braking means when the trailer connecting means is connected to the trailer and the remote control means remotely controls operative engagement of the pneumatic system.

### BRIEF DESCRIPTION OF THE FIGURES

Further aspects and advantages of the present invention will become better understood with reference to the description in association with the following Figures, wherein:

FIG. 1 is a top perspective view of an off-road dolly in accordance with a first embodiment of the present invention;

FIG. 2 is a side view of the off-road dolly shown in FIG. 1;

FIG. 3 a side view of the off-road dolly shown in FIG. 1 when connected to a trailer and to a forklift as propulsion means;

FIG. 4 is a top view of the off-road dolly shown in FIG. 1 when connected to a trailer and to a forklift as propulsion means;

FIG. 5 is a schematic diagram of a pneumatic system of the off-road dolly of FIG. 1;

FIG. 6 is a schematic diagram of an electrical circuit of the off-road dolly shown in FIG. 1;

FIG. 7 is a perspective view of an off-road dolly in accordance with a second embodiment of the invention;

FIG. 8 is a perspective view of the interior of the off-road dolly of FIG. 7 with the cover removed;

FIG. 9 is a side view of the interior of the off-road dolly of FIG. 7 with the cover removed;

FIG. 10 is a top view of view of the off-road dolly shown in FIG. 1 when connected to a trailer; and

FIG. 11 is a perspective view of an off-road dolly in accordance with a third embodiment of the present invention.

### DETAILED DESCRIPTION OF THE PREFERRED EMBODIMENTS

With reference to the annexed Figures embodiments of the present invention will be herein described for indicative purpose and by no means as of limitation.

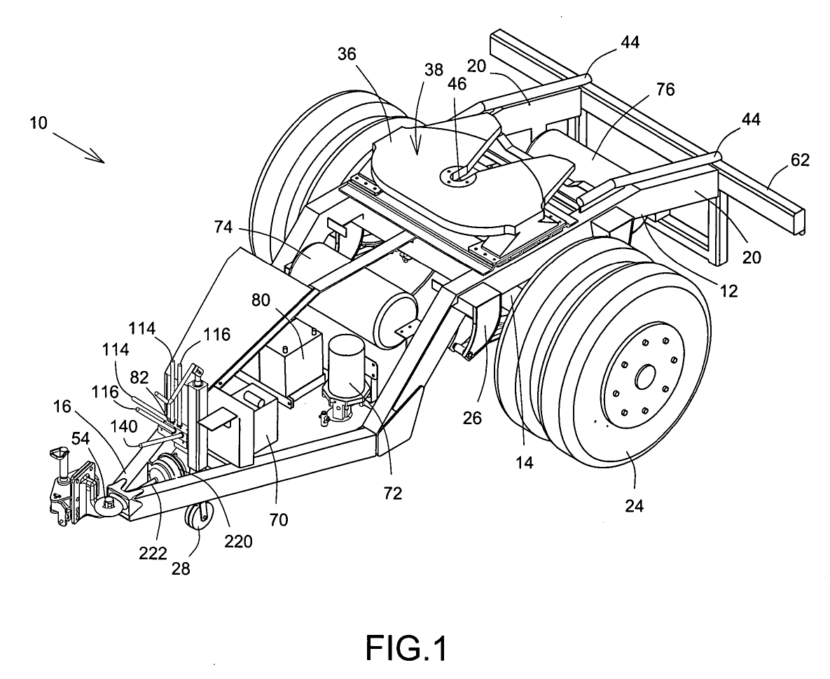

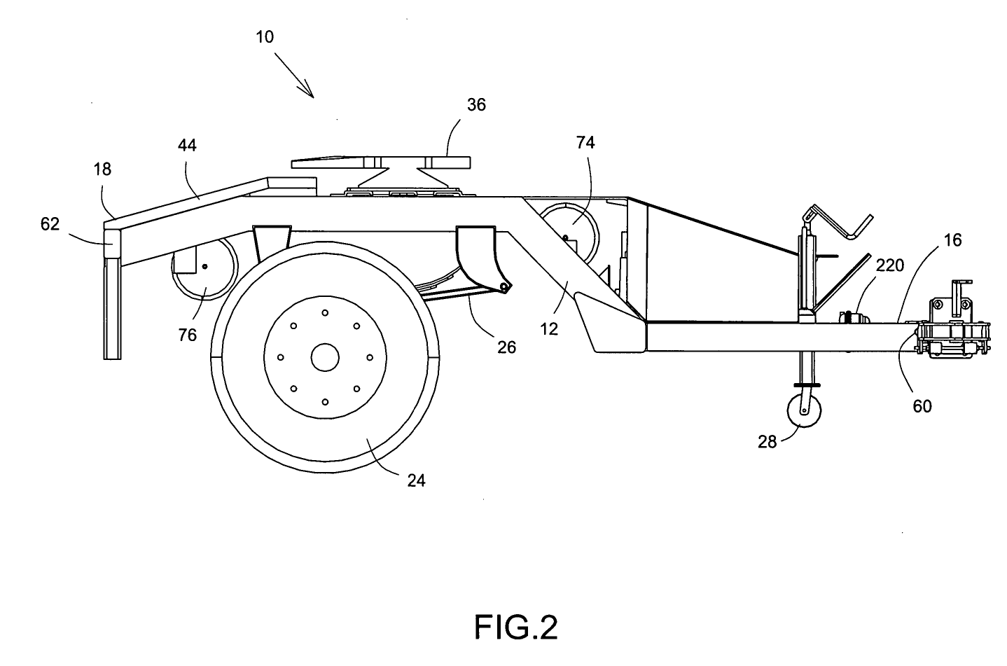

Referring now to FIGS. 1, 2, 3, and 4, off-road dolly 10 has a metal dolly chassis 12 with a heavy duty axle 14 mounted thereunder at a position intermediate dolly first end 16 and generally opposed dolly second end 18 of off-road dolly 10 and extending transversely between opposing sides 20 of off-road dolly 10 which extend longitudinally between dolly first and second ends 16, 18. Heavy duty axle 14 has dolly primary wheels 24 mounted on opposing axle ends of axle 14 which support, along with axle 14, the mass of trailer 22 when connected to off-road dolly 10. Axle 14 is mounted to dolly chassis 12 with a flat bar suspension 26, best shown in FIG. 2. Axle 14 is designed to support a mass of at least 25000 pounds, thereby assuring that off-road dolly 10 can support trailer 22 and cargo, not shown, carried therein. In addition, off-road dolly 10 has at least one dolly secondary wheel 28 for facilitating movement of off-road dolly 10 when not connected to trailer 22 or propulsion means. Propulsion means is forklift 32 in the first embodiment.

Off-road dolly 10 is connected to trailer 22 using trailer connecting means. In the embodiment, trailer connecting means is a fifth wheel 36 on a dolly upper face 38 of the off-road dolly 10 which generally faces the trailer 22. Off-road dolly 10 is connected to trailer 22 by connecting fifth wheel 36 to a pin, not shown, extending downwardly away from trailer lower face 40 of trailer 22 to from a pivotal connection therewith. Thus, the pin and fifth wheel 36 form a trailer connection axis 42 and the fifth wheel 36 allows rotation of trailer 22, relative to off-road dolly 10, about trailer connection axis 42 through rotation range 30 which circumferentially spans at least 180 degrees. To facilitate placement of trailer 22 on off-road dolly 10 and connection with fifth wheel 36, support bars 44 extend on opposing sides 20 of off-road dolly 10 from a position proximal fifth wheel 36 towards dolly second end 18. Support bars 44 support mass of trailer 22 while trailer 22 is slid thereover and into connecting slot 46 of fifth wheel 36.

Fifth wheel 36 is positioned on off-road dolly 10 such that the trailer connection axis 42 is offset towards dolly first end 16 with regard to axle 14. Thus, trailer first end 50 of trailer 22 is situated more closely towards dolly first end 16. This positioning increases mass over off-road dolly 10, even when trailer 22 is rotating around trailer connection axis 42, and thereby impedes off-road dolly 10 from being raised off the ground, thus improving stability of off-road dolly 10 and trailer 22 when trailer 22 is being moved therewith. This increased stability is highly desirable in off-road environments, especially when such environments are situated indoors, such as in factories having expensive equipment.

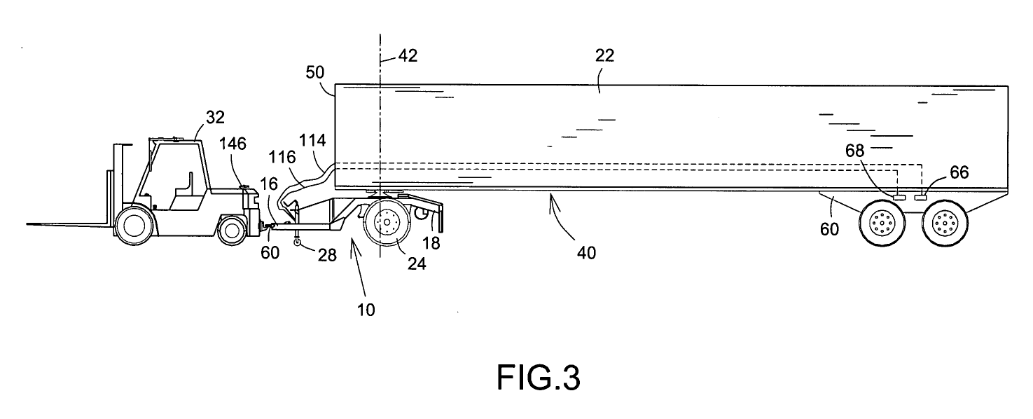

Propulsion means, i.e. forklift 32 in first embodiment, is connectable to off-road dolly 10 and provides a propulsion force for driving a propulsion motion of the propulsion means and off-road dolly 10 and a corresponding trailer motion of trailer 22. Forklift 32, is connected using propulsion connecting means. In the first embodiment, propulsion connecting means is drawbar 54 connectable to forklift 32 and around which forklift 32 may turn and rotate to provide maneuverability for off-road displacement of trailer 22. It should be noted that, as best shown in FIG. 3, propulsion connecting means, i.e. drawbar 54, is situated low to the ground and below axle 14 of off-road dolly 10. This positioning of drawbar 54 helps maintain a low center of gravity for forklift 32 and off-road dolly 10 and reduces risk of upset of forklift 32 and off-road dolly 10, thus increasing stability of off-road dolly 10 and forklift 32. A rear bumper 62 disposed on dolly second end 18 facilitates shock absorption by off-road dolly 10 and reduces lurching and swinging thereof. Navigation of off-road dolly 10 and trailer 22 is assisted by mirrors 48 on forklift 32.

Given the relatively small size of forklift 32, compared to other propulsion means such as trucks, use of forklift 32 as propulsion means facilitates displacement of trailer 22 with off-road dolly 10 in off-road environments, especially off-road environments where space is limited. However, it will be apparent to one skilled in the art that other machines may be connected to off-road dolly 10 as propulsion means provided they are of appropriate size for use in off-road environment and are capable of displacing mass of trailer 22 and cargo therein. In addition, drawbar 54 may be substituted with any other propulsion connecting means capable of connecting off-road dolly 10 and propulsion means and that offers similar rotating and maneuvering capability for propulsion means and off-road dolly 10 when connected thereto.

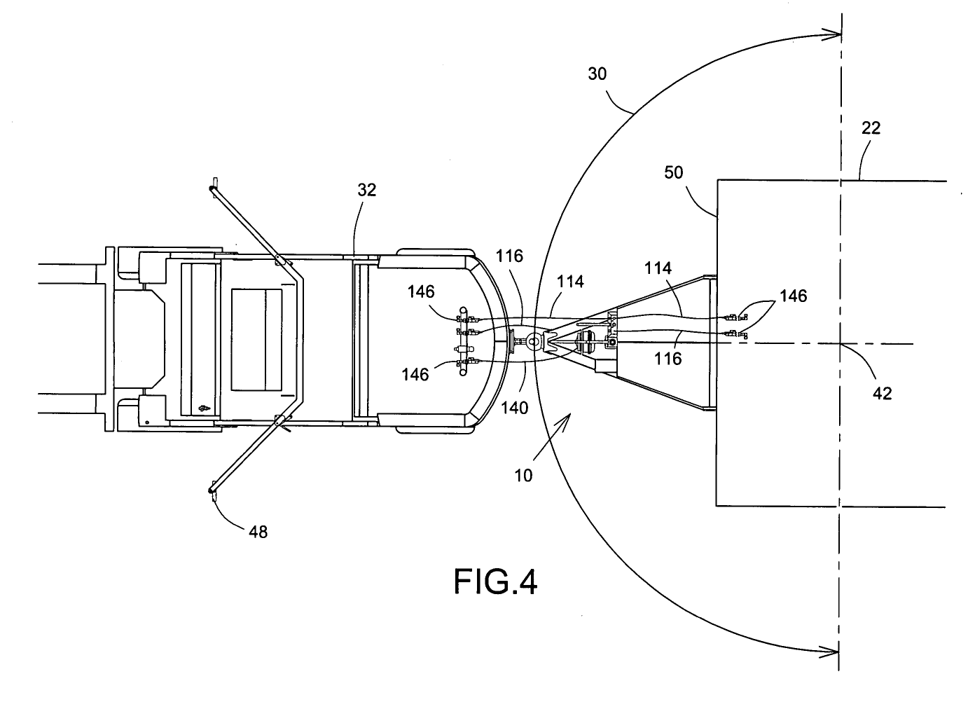

Referring again to FIG. 1 in conjunction with FIGS. 3 and 4, off-road dolly 10 has air compressor 70 which provides compressed air for braking among other things, and air dryer 72 for drying air compressed thereby. Compressed air, dried by air dryer 72, is stored in first air tank 74 and second air tank 76. A dolly power supply, i.e. at least one battery 80 for the embodiment, provides electrical power to off-road dolly 10 for, among other things, compressor 70. A dolly air distributor block 82, from which brake lines 114, 116 extend, supplies compressed air from air compressor 70 on off-road dolly 10 through brake lines 114, 116 to trailer 22 for trailer braking means 60. Dolly air distributor block 82 also provides compressed air to remote control means, shown generally as 104 and situated on forklift 32 in the first embodiment, via pneumatic output line 140 which connects to forklift 32, i.e. propulsion means.

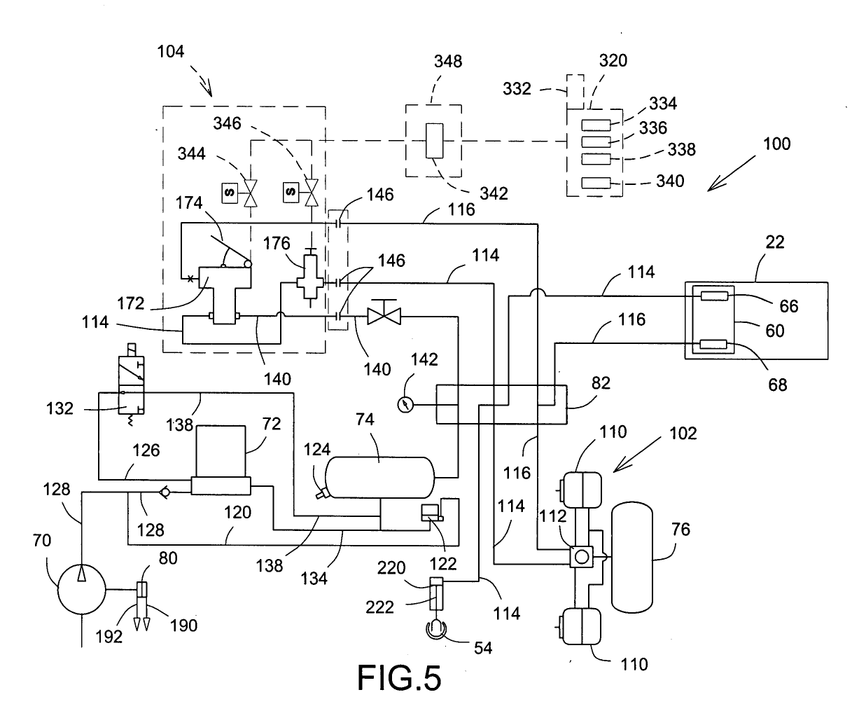

Referring now to FIG. 1 in conjunction with FIG. 5, the functioning of compressor 70 and braking is now explained in further detail. Off-road dolly 10 has pneumatic system, shown generally as 100. Pneumatic system 100 operatively connects dolly braking means 102, air compressor 70, air dryer 72, drawbar 54, first and second air tanks 74, 76, dryer circuit purge valve 132, purge valve 122, and air distribution block 82. In addition, pneumatic system 100 is operatively connectable, using brake lines 114, 116 connected to air distribution block 82, to trailer braking means and to remote control means 104, using pneumatic output line 140, as described above.

Pneumatic system 100 provides compressed air for selective and synchronized operational engagement, using remote control means 104, of dolly braking means 102 shown generally as 102 and situated on off-road dolly 10 for braking propulsion motion thereof, and trailer braking means 60 situated on trailer 22 for braking trailer motion which corresponds to propulsion motion. In the first embodiment, remote control means 104 is situated on forklift 32 such that it may be synchronously and selectively operationally engaged with propulsion braking means, not shown, of forklift 32 which brakes propulsion motion of forklift 32 driven by propulsion force generated by forklift 32. Thus, trailer braking means 60 and dolly braking means 102 are selectively operationally engageable, i.e. activated and deactivated, via remote control means 104, by operationally engaging the propulsion braking means which operatively engages the remote control means 104. This, advantageously, provides for easy and simultaneous braking of propulsion means, i.e. forklift 32, off-road dolly 10, and trailer 22.

The dolly braking means 102 consists of dolly service air brakes, not shown, and dolly parking brakes, not shown, housed in dolly brake chambers 110 connected to dolly relay valve 112 and to second air tank 76 which receives and stores compressed air compressed in air compressor 70 and initially stored in first air tank 74. Trailer braking means 60 consist of trailer service air brakes 68 and trailer parking brakes 66. Trailer braking means 60 may also optionally have a trailer air tank, not shown, for storing compressed air for trailer service air brakes 68 and a trailer relay valve, not shown, which may function in the same manner as second air tank 76 and dolly relay valve 112. Service air brakes and parking brakes using relay valves and air tanks of compressed air are well known in the art, and, therefore, dolly braking means 102 and trailer braking means 60 will only be briefly described herein. Propulsion braking means for propulsion means in first embodiment i.e. forklift 32, consists of a basic hydraulic brake system, also well known in the art. It will be apparent to one skilled in the art that the present invention may be adapted to other types of brake systems for propulsion braking means, dolly braking means 102, and trailer braking means 60.

Control and synchronization of trailer braking means 60 and dolly braking means 102 is achieved by flow of compressed air over brake lines 114, 116. A service brake flow of compressed air, at an adjustable first air pressure level, circulates through service brake line 116 to dolly relay valve 112 for controlling dolly service air brakes. The first air pressure level is adjusted by a user controlled pressure regulator valve 174, part of remote control means 102, which receives compressed air from first air tank 74 where compressed air is initially stored. A parking brake flow of compressed air, also initially stored in first air tank 74, is received by relay valve 112 from parking brake line 114 and is subsequently transmitted from relay valve 112 to second air tank 76 and dolly brake chambers 110. Unlike service brake flow in service brake line 116, parking brake flow in parking brake line 114, as well as second air tank 76, have a generally constant second air pressure level.

With more specific regard to parking brakes, second air pressure level generally never falls below the pressure level in first air tank 74, provided system 100 is functioning normally without leaks or other faults. Provided second air pressure level of parking brake flow in parking brake line 114 is above a minimum parking brake air pressure level, for example 60 pounds per square inch, dolly relay valve 112 will relay sufficient compressed air to dolly parking brakes to provide deactivation thereof. Dolly parking brakes, which may be spring brakes, engage automatically should the supply of compressed air over parking brake line 114, i.e. parking brake flow, be interrupted or if second air pressure level thereof should otherwise fall below minimum parking brake air pressure, as dolly relay valve 112 will receive insufficient compressed air to relay to dolly parking brakes for deactivation thereof. Trailer parking brakes 66 work in exactly the same fashion as dolly parking brakes, using parking brake line 114 which also extends from air distributor block 82 for connection to trailer braking means 60 on trailer 22. As for dolly service air brakes, compressed air from service brake line 116 received at dolly relay valve 112 causes air relay valve 112 to relay compressed air, including air from second air tank 76, to dolly brake chambers 110 to operatively and selectively engage dolly service air brakes. The level of engagement of dolly service air brakes depends on adjustable first air pressure level of compressed air in service braking line 116. As first air pressure level increases, dolly relay valve 112 ensures that air pressure of compressed air provided from second air tank 76 to dolly service air brakes is similarly increased. Service brake line 116, which also extends from air distributor block 82 for connection with trailer braking means 60 on trailer 22, is used to selectively operatively engage trailer service air brakes 68 and to control the level of engagement thereof in the same fashion as for dolly service air brakes. Thus, in summary, service brake line 116 acts essentially as a control line with service brake flow for adjustably operatively engaging dolly service air brakes and trailer service air brakes 68. In contrast, parking brake line acts as an air supply conduit for supplying the compressed air necessary for providing the force required to provide the desired level of engagement of dolly and trailer service air brakes 68 and for disengaging dolly and trailer parking brakes 66.

Having described the basic functioning of the trailer braking means 60 and dolly braking means 102, remote control means 104 and the flow of air through pneumatic system 100 are now explained in greater detail. When pneumatic system 100 is operatively engaged, air compressor 70 outputs compressed air through compressor output line 128 to air dryer 72. Compressed air is dried in air dryer 72 to remove moisture therefrom, as moisture may have a detrimental effect on the functioning of air brakes. Compressed air then circulates through first tank line 134 to first air tank 74. In addition, first air tank 74 has drain valve 124 for draining moisture from first air tank 74.

Purge valve 122, connected between first tank line 134 and purge line 120, is a solenoid valve which acts as a pressure switch and causes air compressor 70 to be deactivated when a first tank air pressure level of compressed air in first air tank 74 rises to a predetermined maximum safe tank pressure level. Purge valve 122 also triggers reactivation of air compressor 70 when first tank air pressure level descends to a minimum pre-determined safe tank pressure level. Further, when purge valve 122 deactivates air compressor 70, purge valve 122 purges air from compressor output line 128 by drawing air from compressor output line 128 through purge line 120 into purge valve 122, from which air is purged. This purging of air reduces pressure in the heads of air compressor 70 and thereby facilitates subsequent activation air compressor 70 thereof when compression is once again required.

While air compressor 70 is activated, a small quantity of compressed air is circulated in a dryer circuit from first air tank 74 through line 138 to dryer circuit valve 132 connected thereto and, subsequently, from dryer circuit valve 132 through line 126 back to air dryer 72 for cleansing thereof. The air then is re-circulated through first tank line 134 back to first air tank 74. Dryer circuit valve 132, which may be a solenoid valve, is electronically operated and provides the connection between lines 126, 138 while air compressor 70 is activated. When air compressor 70 is deactivated, the connection between lines 126, 138 through dryer purge valve 132 is terminated to permit purging of air in air dryer 72. Specifically, when air compressor 70 is deactivated, pressurization of air flow towards air dryer 72 in line 126 is terminated, allowing air to flow through line 126 from air dryer 72 to dryer circuit valve 132, where the air from air dryer 72 is purged. Connection between lines 126, 138 through dryer circuit valve 132 is subsequently re-established when air compressor 70 is subsequently activated again to recommence flow of compressed air to first air tank 74.

After being dried in air dryer 72, compressed air passes from first air tank 74 through pneumatic output line 140, which carries compressed air from first air tank 72 through air distributor block 82 towards remote control means 104. Pneumatic output line has pressure gauge 142 connected thereto for indicating the air pressure level in pneumatic output line 140, which is equal to the air pressure level of first air tank 72. Pneumatic output line 140 exits air distributor block 82, carrying compressed air, and is connected to remote control means 104, situated on forklift 32 in first embodiment, with connectors 146. Remote control means 104 is also connected to parking brake line 114 and service brake line 116, which serve as outputs therefrom and which are also connected using connectors 146 to off-road dolly 10 at air distributor block 82, from which brake lines 114, 116 are connected internally to dolly braking means 102 and, again using connectors 146, extended and connected from dolly 10 to trailer braking means 60. Thus, pneumatic system 100 is operatively connected to propulsion means, i.e. forklift 32 in the first embodiment, as well as to remote control means 104 thereon, in addition to dolly braking means 102 and trailer braking means 60. It should be noted that the connections for lines 114, 116, 140 between dolly 10, remote control means 104, and trailer 22 can be extended by attaching additional lines, i.e. suitable air-tight hoses, having connectors 146 to lines 114, 116, 120 and to dolly 10, including air distributor block 82, remote control means 104, and trailer. Further, locations shown in the figures for connections of lines 114, 116, 140 and connectors 146 on block 82, forklift 32, and trailer 22 are exemplary. Connectors 146 may be located elsewhere, as may be block 82. It is not the intention of the inventors to limit the scope of the invention to the exact configurations or locations for connecting lines 114,116, 140 on trailer 22, forklift 32, or block 82 to those shown herein.

When passing through remote control means 104, compressed air first passes through pressure regulator valve 172 of remote control means 104 to which pneumatic output line 140 is connected. Pressure regulator valve 172 has lever 174 which adjusts and regulates first air pressure level of compressed air allowed to pass through pressure regulator valve 172 into service brake line 116 as service brake flow. Thus, pressure regulator valve 172 is operatively connected, through service brake line 116 to dolly braking means 102, specifically dolly relay valve 112, and to trailer service air brakes 68 of trailer braking means 60, and permits adjustment of first air pressure level of service brake flow in service brake line 116. More specifically, depressing lever 174 increases first air pressure level, which is reduced while lever 174 is released. Since service brake flow at first air pressure level operationally engages dolly service air brakes, via relay of air provided by dolly relay valve 112, as well as trailer service air brakes 68, and the level of operational engagement thereof depends on first pressure level, use of lever 174 provides synchronized, and adjustable, operational engagement of trailer service air brakes 68 and dolly service air brakes. Lever 174 may be situated directly under a foot pedal, not shown, on forklift 32, used to operate propulsion braking means thereof, thus allowing a user to depress and release lever 174 as foot pedal is depressed and released for further synchronizing operational engagement of trailer service air brakes 68 and dolly service air brakes with propulsion braking means on forklift 32. Pressure regulator valve 172 is also connected to parking brake line 114. However, compressed air passes directly through pressure regulator valve 172 into parking brake line 114 whether lever 174 is depressed or not.

Should second air pressure level fall below the minimum parking brake pressure level, safety valve 176 will engage to cut off flow of compressed air through parking brake line 114 to dolly braking means 102, specifically dolly relay valve 112, and trailer parking brakes 66. Advantageously, dolly relay valve 112 terminates all flow of air to dolly parking brakes, and dolly service brakes when dolly relay valve 112 ceases to receive air through line parking brake line 114, ensuring no delays between engagement of dolly parking brakes and trailer parking brakes 66. Further, circulation of air over parking brake line 114 from first air tank 74 and from second air tank 76 to dolly brake means 114 will be halted, which conserves air in tanks 74, 76 and reduces time required to subsequently fill tanks 74, 76. Thus, automatic engagement of trailer parking brakes 66 and dolly parking brakes is precisely synchronized and system 100 provides a synchronized back-up mechanism for automatically braking trailer 22 and dolly 10 using, respectively, trailer parking brakes 66 and dolly parking brakes.

Second air pressure level will fall below minimum parking brake pressure level, for example, whenever pressure in first air tank 74 falls below this minimum parking brake pressure level. This may occur when air compressor 70 is disengaged and cannot be re-engaged in time to replenish first air tank 74 to minimum parking brake pressure level. For instance, power to the compressor 70 from the battery 80 could be interrupted for a period in which pressure in first tank 74 falls below minimum parking brake pressure level. Leakage of air in pneumatic system 100 could also cause such a fall in second air pressure level. Disconnecting pneumatic system 100 from remote control means 104 on forklift 32 could also reduce second air pressure level below minimum parking brake pressure level as connection between pneumatic output line 140 and parking brake line 114 would be interrupted. Safety valve 176 may also be manually engaged by a user to manually, and synchronously, operatively engage trailer parking brake and dolly parking brake, which may also be subsequently operatively disengaged by manually disengaging safety valve 176, provided air pressure in first air tank 76 is not below minimum parking brake pressure level.

When safety valve 176 is not engaged, compressed air, i.e. parking brake flow, at second pressure level flows therethrough into parking brake line 114 and then to dolly relay valve 112, where it is relayed to second air tank 76 and dolly braking means 102 to engage dolly parking brake, and engage, based on service brake flow receive by dolly relay valve 112, dolly service air brakes. Compressed air at second pressure level also flows through parking brake line 114 into trailer braking means 60 and, if present, fills up trailer air tank, in addition to disengaging trailer parking brakes 66.

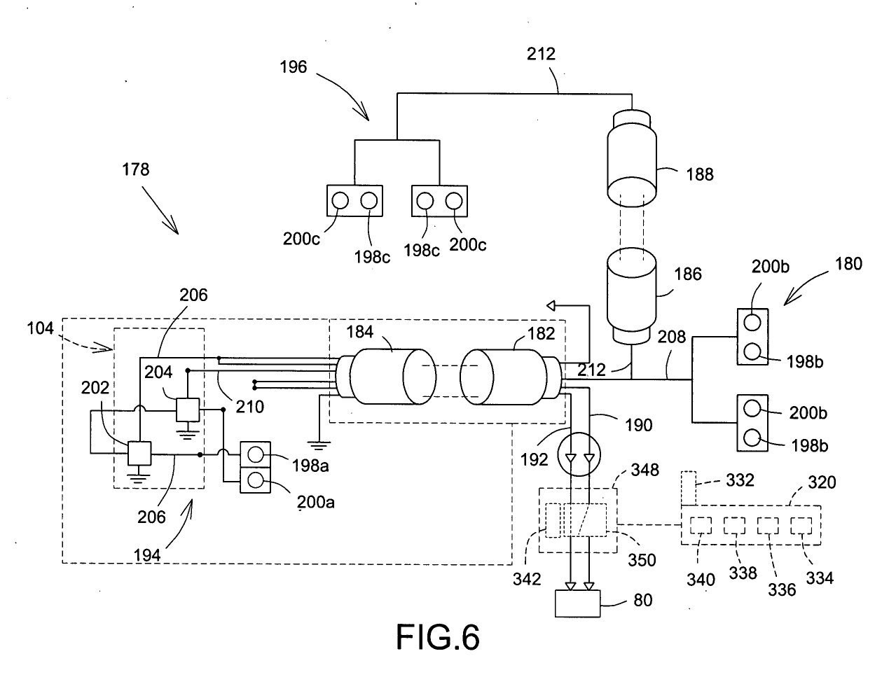

Referring now to FIG. 6 in conjunction with FIG. 5, pneumatic system 100 is also connected to an electrical circuit, shown generally as 178 which, generally speaking, connects battery 80 to the pneumatic system 100 and provides electrical power for dolly signal lighting system, shown generally as 180 and situated on rear bumper 62, and air compressor 70. A portion of electrical circuit 178 is co-located with remote control means 104 on propulsion means, i.e. forklift 32 in the embodiment, and provides for operative connection to a propulsion means lighting system, shown generally as 194, thereof. Specifically, a first electrical plug 182 extending from off-road dolly 10 is connected to a second electrical plug 184 on forklift 32 to ensure connection of electrical circuit 178 between off-road dolly 10 and forklift 32. Similarly, a third electrical plug 186 is connectable to a fourth electrical plug 188 for connecting electrical circuit 178 to a trailer electrical system, not shown, which controls, among other things, a trailer signal lighting system, shown generally as 196.

Referring still to FIG. 6, in conjunction with FIG. 5, as can be seen, first battery power line 190 and second battery power line 192 are connected to air compressor 70 and battery 80, and extend to first electrical plug 182. However, first and second battery power lines 190, 192 are not connected to each other on off-road dolly 10 or in first electrical plug 182. Rather, first battery power line 190 and second battery power line 192 are connected in second electrical plug 184. Thus, electrical circuit 178 is not established, i.e. connected, to provide electrical power to pneumatic system 100 until first and second electrical plugs 182, 184 are connected to each other. Should first and second electrical plugs 182, 184 be disconnected from each other, electrical power to air compressor 70 will be terminated, thus causing air compressor 70 to be operatively disengaged. This will lead to drop in pressure below minimum parking brake air pressure level and will, advantageously from a safety perspective, cause dolly parking brakes and trailer parking brakes 66 to automatically and synchronously operatively engage. Similarly, since electrical circuit 178 between battery 80 and air compressor 70 is established when first and second electrical plugs 182, 184 are connected to each other, off-road dolly can be configured such that connecting first and second electrical plugs 182, 184 can automatically cause compressor 70, and pneumatic system 100 to automatically operationally engage to provide synchronized operational engagement of trailer service air brakes 68 and dolly service air brakes, as explained previously.

As in the case of pneumatic system 100, dolly signal lighting system 180 also is disconnected from battery 80 when first and second electrical plug 182, 184 are disconnected from each other. To operatively connect dolly signal lighting system 180 to propulsion means signal lighting system 194 on forklift 32 and remote control means 104 thereon, first and second electrical plugs 182, 184 must be connected to each other. Further, to operatively connect trailer signal lighting system 196 to dolly signal lighting system 180 and propulsion means signal lighting system 194 for synchronized engagement with remote control means 104, third and forth electrical plugs 186, 188 must be connected to each other, in addition to first and second electrical plugs 182, 184.

Dolly signal light system 180, propulsion means signal lighting system 194, and trailer signal light system 196 have braking signal lights 198 to indicate braking and direction signal lights 200 to indicate direction of motion, such as when turning occurs. More specifically, and referring still to FIG. 5, propulsion means, i.e. forklift 32 in the embodiment, has braking signal lights 198a which indicate that propulsion means braking means have been operatively engaged and propulsion means directional signal lights 200a for indicating a direction of propulsion motion of propulsion means, i.e. forklift 32. First relay 202 is installed on forklift 32 and is connected to propulsion means braking signal light 198a such that, when propulsion means braking signal light 198a is engaged, first relay 202 is closed creating an electrical circuit between propulsion braking signal light line 206 and dolly signal lighting system control line 208 which causes dolly braking signal light 198b to be illuminated. Similarly, a second relay 204 is installed on forklift 32 which closes and creates an electrical circuit between propulsion direction signal light line 210 and dolly signal light system control line 208 which causes dolly directional signal light 200b to be illuminated when a corresponding propulsion directional signal light 200a is illuminated. Trailer signal light system control line 212, connected to dolly signal light system control line 208, causes corresponding trailer directional signal light 200c and trailer braking signal light 198c to be similarly illuminated. Thus, selective operational engagement, i.e. illumination, of braking signal lights 198 and directional signal lights 200 is synchronized and controlled using first and second relays 202, 204, which form part of remote control means 102.

Finally, referring to FIG. 5 in conjunction with FIG. 1, pneumatic system 100 is also connected to drawbar 54. Specifically, parking brake line 114 is connected to a pneumatic cylinder 220 and provides a drawbar flow of compressed air from pneumatic system 100 at second pressure level air thereto. A piston 222 is disposed within the pneumatic cylinder 220 on a first piston end thereof, not shown. The second piston end, not shown, of piston 222 is connected to drawbar 54. Thus piston 222 is disposed in within pneumatic cylinder 220 and connected to drawbar 54. The drawbar flow of compressed air applies an outward force, directed generally away from off-road dolly 10, upon piston 222 at first piston end and, thereby, upon drawbar 54. Thus, due to the outward force, the drawbar flow impedes collision between off-road dolly 10 and the propulsion means, i.e. forklift 32, and attenuates shocks when the off-road dolly 10 is moved suddenly towards forklift 32.

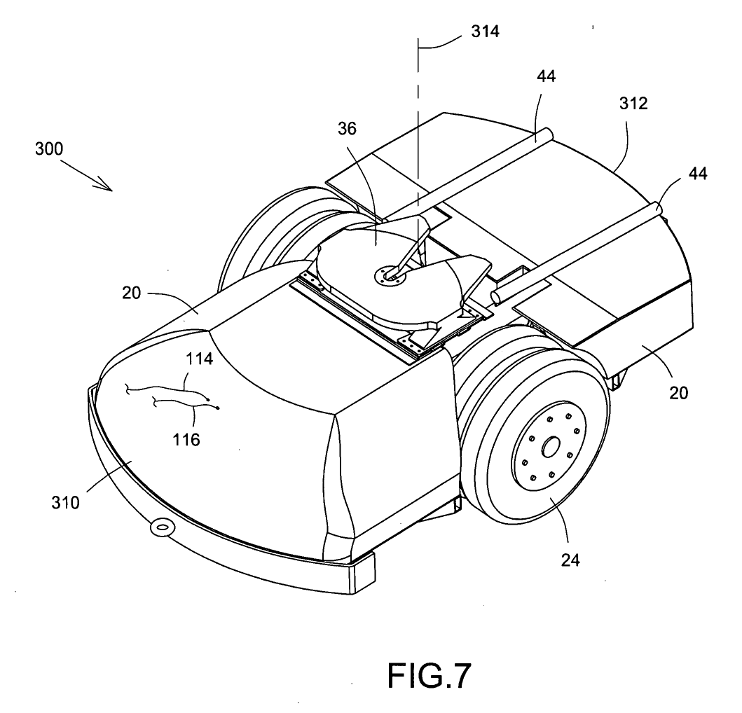

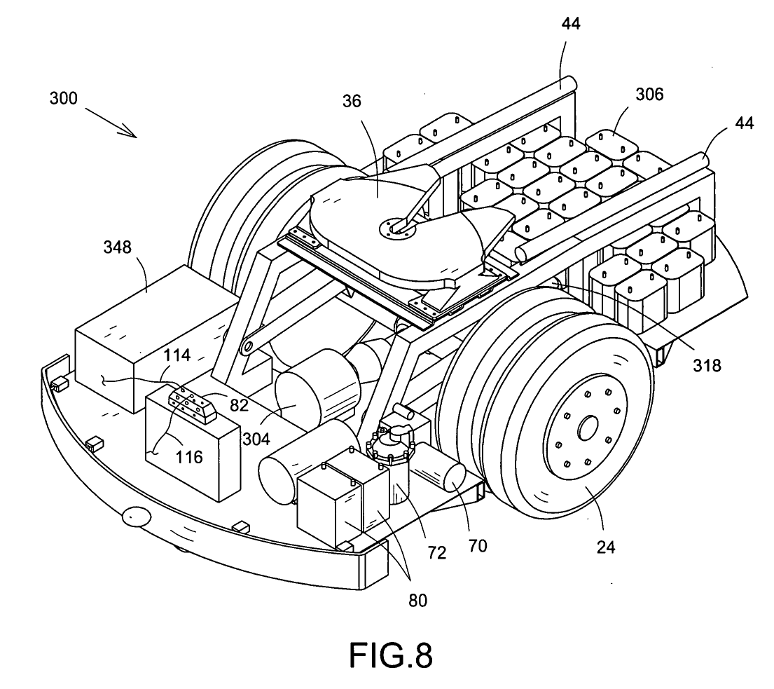

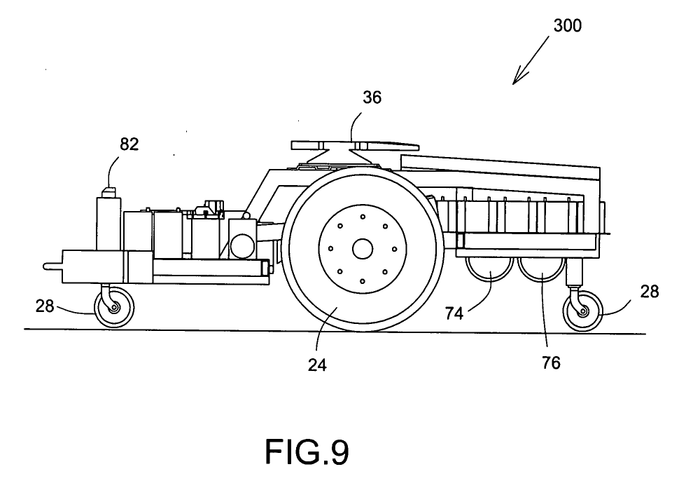

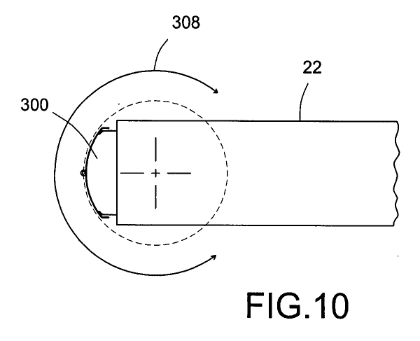

Turning now to FIGS. 7, 8, 9, and 10, therein is shown an off-road dolly, shown generally as 300, in accordance with a second embodiment of the present invention. Off-road dolly 300 in the second embodiment is similar to that of the first embodiment with regard to trailer connecting means fifth wheel 36, pneumatic system 100, and synchronization of trailer braking means 60 with dolly braking means 102. However, for off-road dolly 300 of second embodiment, off-road dolly 300 itself is the propulsion means as propulsion force for dolly motion of off-road dolly 300 and trailer 22 is provided by electrical motor 304 situated on off-road dolly 300 and operatively connected to electrical motor batteries 306, namely thirty 12 volt motor batteries 306, for providing electrical power to electrical motor 304. Battery 80 is also present on off-road dolly 300, as in the first embodiment, and continues to provide power to air compressor 70 and dolly signal lighting system 180.

As in the first embodiment, trailer connecting means, i.e. fifth wheel 36, is offset with regard to dolly axle 14 to provide additional stability. However, since off-road dolly 300 serves as propulsion means, off-road dolly 300 permits rotation of trailer 22 about trailer connection axis 42 throughout a rotation range 308 spanning a greater angle than rotation range 30 of off-road dolly of the first embodiment, since forklift 32 does not have to be accommodated. This superior rotation range 308 is enhanced by the fact that dolly primary wheels 24 are situated substantially at a central position between first end 310 and second end 312 of off-road dolly 300. Turning is effected either by braking or slowing one of the primary wheels 24 while the other primary wheel 24 turns at a higher speed, thus keeping dolly rotation axis 314 proximally centrally situated in between dolly primary wheels 24, which reduces space required for changes in direction, such as turns, increases maneuverability, and enhances stability of off-road dolly 300. Since off-road dolly 300 is self-propelled, an additional dolly secondary wheel 28, not present in off-road dolly 10 of the first embodiment, is situated on second end 312 thereof. Dolly 300 could also have multiple primary wheels 24, as propulsion wheels, situated in substantially central position on sides 20 and these wheels could be covered individually with wheel tracks or, for each side, collectively covered by a single wheel track extending around all wheels 24 on each side.

Off-road dolly 300 of second embodiment is shown with a pneumatic suspension 318, which replaces flat bar suspension 26 shown for first embodiment. Pneumatic suspension 318 allows dolly 300 to be placed under trailer 22 and attached thereto when the pneumatic suspension 318 is completely lowered, without requiring placement of trailer 22 on supports, not shown. Pneumatic suspension 318 can then be activated to raise trailer 22 for displacement with dolly 300. A fifth-wheel suspension, not shown, could, alternatively, be used in which a cylinder, not shown, placed under the fifth wheel 36 could be used to raise the fifth wheel 36 and trailer 22 attached thereto. It should be noted that pneumatic suspension 318 and fifth-wheel suspension described herein could also be implemented for dolly 100 of the first embodiment.

Off road dolly 300 of second embodiment has first and second air tanks, respectively 74, 76 as in off-road dolly 10 of first embodiment. Similarly, as previously stated, off-road dolly 300 has pneumatic system 100 and dolly braking means 102, including dolly service air brakes and dolly parking brakes, which are operatively connected to trailer braking means 60, including trailer service air brakes 68 and trailer parking brakes 66 and are synchronized therewith. Dolly signal lighting system 180 is also synchronized with trailer signal lighting system 196.

Referring again to FIGS. 5 and 6, since off-road dolly 300 itself comprises the propulsion means, remote control means 320 for selectively operationally engaging dolly braking means 102 and trailer braking means 60, along with dolly signal lighting system 180 and trailer signal lighting system 196, is different than remote control means 104 of off-road dolly 10 of the first embodiment. Specifically, remote control means 320 is not situated on forklift 32 and propulsion means does not have a propulsion signal light system 210 or propulsion braking means separate from off-road dolly 300. In addition, remote control means 320 must also provide steering, i.e. directional control, for off-road dolly 300. Thus, electrical circuit 178, pneumatic system 100, and remote control means 300 are modified. The differences between off-road dolly 10 of first embodiment and off-road dolly 300 of second embodiment are indicated with the assistance of dotted lines in FIGS. 5 and 6.

With regard to pneumatic system 100, safety valve 176 and pressure regulator valve 172 are situated on off-road dolly 300 of the second embodiment. Accordingly, connectors 146 for connecting service brake line 116, parking brake line 114, and pneumatic output line 140 to remote control means 320 are not present as they are for remote control means 104 in the first embodiment. Air distributor block 82 is present but now only has connectors 146 for extending service brake line 116 and parking brake line 114 to trailer 22. Remote control means 320 has transmitter 332 which transmits electrical braking control signals, namely air brake control signals for service air brakes and parking brake control signals for parking brakes, and electrical directional signal light control signals in accordance to manipulation by user of, respectively, air brake control 334, parking brake control 336, and directional signal light control 338 on remote control means 320. These signals are received by receiver 342. Receiver 342 is operatively connected to first solenoid valve 344, connected to lever 174, and second solenoid valve 346 which are operatively connected, respectively to pressure regulator valve 172 and safety valve 176. Thus, when user manipulates service air brake control 334, service air brake control signal is transmitted from remote control means 320 using transmitter 332 and is received by receiver 342 which activates first solenoid valve 344 for depressing and releasing lever 174 to operationally engage dolly service air brakes. When released, parking brake control 336 activates, via receiver 342, second solenoid valve 346 which operatively engages safety valve 176 for activating parking brakes on both off-road dolly 300 and trailer 22. Thus, parking brake control 336 must normally be depressed to disengage dolly parking brakes and trailer parking brakes 66. Synchronization of trailer parking brakes 66 with dolly parking brakes and trailer service air brakes 68 with dolly service air brakes is otherwise identical to off-road dolly 10 of the first embodiment.

With regard to synchronized and selective operational engagement of directional signal lights 200 and braking signal lights 198 on off-road dolly 320 and trailer 22, first and second electrical plugs 182, 184 are not present and first relay 202 and second relay 204 are also omitted. Instead, receiver 342 is operatively connected to dolly signal lighting system control line 208, which remains connected to trailer signal lighting system control line 212 as for off-road dolly 10 of first embodiment. When directional signal light control 338 on remote control means 320 is manipulated by user, a directional signal light control signal is generated and transmitted by transmitter 332 to receiver 342. Receiver 342 receives the directional signal light control signal and operatively engages, using dolly signal lighting system control line 208, the dolly directional signal light 200b corresponding thereto. Provided that third and forth electrical plugs 186, 188 are connected to each other, corresponding trailer directional signal light 200c will also be operatively engaged. For braking signal lights 198, receiver 342 automatically engages braking signal lights 198 using dolly signal lighting system control line 208, and trailer signal lighting system control line 212 if electrical plugs 186, 188 are connected to each other, when receiver 342 receives a service air brake control signal or parking brake control signal from transmitter for operatively engaging, respectively, dolly service air brakes or dolly parking brakes. Finally, receiver 342 is operatively connected to electrical motor 304 and sends signals thereto to cause one dolly primary wheel 24 to slow or stop while other primary wheel turns 24 at a higher speed to effect changes in direction when steering control signals are received by receiver 342 from transmitter 332 as a result of steering control 340 of remote control means 320 being manipulated by user. Receiver 342 is housed in control box, 348, shown in FIG. 6. Solenoid valves 344, 346, lever 174, pressure regulator valve 172, and safety valve 176 may also, optionally, be situated in control box 348.

First and second electrical lines 190, 192, connecting compressor 70 to battery 80 are connected to each other in control box 348 and are connectable by a third relay 350 operatively controlled by receiver 342. Should receiver 342 stop receiving signals from transmitter 332 of remote control means 320 for a predetermined period of time, third relay 350 will be opened, thus disconnecting compressor 70 from battery 80 and deactivating compressor 70.

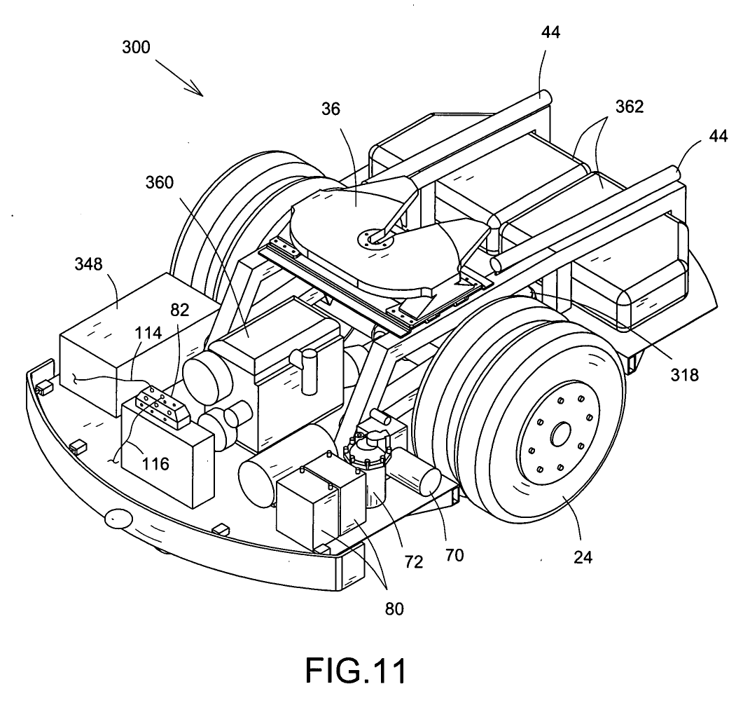

Turning now to FIG. 11, therein is shown an off-road dolly 300a in accordance with a third embodiment of the present invention. With one exception, off-road dolly 300a is identical to, and functions in exactly the same manner as, off road dolly 300 of second embodiment. However, rather than using an electrical motor 304 connected to electrical motor batteries 306, off road dolly 300a provides propulsion from a gas driven motor 360, as propulsion means, which consumes gasoline as fuel that is stored in fuel reservoirs 362. It should be noted that other types of motors, such as propane fuel and diesel fuel motors, may also be used for second and third embodiments as propulsion means.

Transmitter 332 of remote control means 320 and receiver 342 in the embodiment are wireless devices, thus providing remote control functions with encumbrance by wires. However, it will be apparent to one skill in the art that wireline systems, having remote control means 320, and more specifically transmitter 332 thereof, connected to receiver by wires 342.

It will further be apparent to one skilled in the art that other embodiments of the present invention may be envisaged. The description provided herein is provided for purposes of illustration and not limitation. While a specific embodiment has been described, those skilled in the art will recognize many alterations that could be made within the spirit of the invention, which is defined solely according to the following claims.

We claim:

1. An off-road dolly for connecting to a propulsion means for off-road displacement of a trailer, the propulsion means driving a propulsion motion of said dolly and a corresponding trailer motion of the trailer, the trailer having a trailer braking means for providing trailer braking of the trailer motion, said dolly comprising:
a trailer connecting means for connecting the trailer to said dolly;
a pneumatic system connectable to the trailer braking means for providing compressed air for operatively engaging the trailer braking means when the trailer is connected to said trailer connecting means; and
a remote control means for remotely controlling operative engagement of said pneumatic system.

2. The off-road dolly of claim 1, wherein said pneumatic system comprises a service brake line connectable to a trailer service air brake of the trailer braking means and through which a trailer service brake flow of said compressed air is provided by said pneumatic system to said trailer service air brake for selectively operatively engaging said trailer service air brake with said remote control means.

3. The off-road dolly of claim 1, wherein said pneumatic system comprises a parking brake line connectable to a trailer parking brake of the trailer braking means and through which a parking brake flow of said compressed air flows for operatively disengaging said trailer parking brake when said pneumatic system is connected to the propulsion means to enable the trailer motion.

4. The off-road dolly of claim 3, further comprising a safety valve disposed on said parking brake line, said safety valve being selectively operatively engageable from said remote control means for selectively terminating said parking brake flow and thereby selectively operatively engaging said trailer parking brake to disable the trailer motion.

5. The off-road dolly of claim 4, wherein said safety valve is further operatively connected by said parking brake line to a dolly parking brake of a dolly braking means situated on said dolly, said dolly parking brake also being disengaged by said parking brake flow and engaged when said parking brake flow is terminated by engaging said safety valve, for respectively providing synchronized operative engagement and disengagement of said dolly parking brake with said trailer parking brake when said safety valve is respectively engaged and disengaged.

6. The off-road dolly of claim 1, further comprising an electrical circuit connectable to a trailer signal lighting system having trailer signal lights for indicating engagement of the trailer braking means and direction of the trailer motion, and to a dolly signal lighting system on said dolly, said dolly signal lighting system having dolly signal lights for indicating engagement of a dolly braking means of said dolly for braking the propulsion motion thereof and direction of the propulsion motion, each said dolly signal light corresponding to a corresponding trailer signal light, said electrical circuit operatively engaging said corresponding trailer signal light when said dolly signal light corresponding thereto is operatively engaged.

7. The off-road dolly of claim 1, further comprising an electrical circuit connecting to said pneumatic system and the propulsion means for providing electrical power to said pneumatic system, said pneumatic system being automatically operatively disengaged when said electrical circuit is disconnected from at least one of said propulsion means and said pneumatic system.

8. The off-road dolly of claim 1, wherein said dolly is situated externally to the propulsion means, said dolly being having a propulsion connecting means for connecting said dolly to the propulsion means.

9. The off-road dolly of claim 8, wherein said remote control means is situated on the propulsion means and comprises a pressure regulator valve operatively connected to said pneumatic system and operatively engageable for adjusting an adjustable first air pressure level of a service brake flow of said compressed air flowing through a service brake line of said pneumatic system connected to a trailer service air brake of the trailer braking means for providing operational engagement of said trailer air service brake.

10. The off-road dolly of claim 9, wherein said pressure regulator valve is situated proximally below a propulsion means brake pedal for controlling a propulsion braking means of the propulsion means for braking the propulsion motion with respect to the propulsion means by depressing said propulsion means brake pedal, said pressure regulator valve being operatively engaged when said brake pedal is depressed, thereby engaging said trailer air service brake when said propulsion means braking system is engaged for synchronizing said operational engagement of said propulsion braking means with said trailer service air brake.

11. The off-road dolly of claim 9, further comprising a dolly braking means on said dolly for further braking the propulsion motion with respect to said dolly, said dolly braking means having a dolly service air brake operatively connected to said service brake line and operatively engaged by said compressed air of said service brake flow at said adjustable first air pressure level, said dolly braking means being thereby synchronously operatively engaged by said pressure regulator valve when said trailer service air brake is selectively operatively engaged therewith.

12. The off-road dolly of claim 8, wherein said propulsion connecting means is situated at a position below said trailer connecting means, said propulsion connecting means having a centre of gravity situated lower than the trailer when the trailer is connected with said trailer connecting means for reducing risk of upset of the propulsion means when providing the propulsion motion.

13. The off-road dolly of claim 12, wherein said propulsion connecting means comprises a drawbar connectable to the propulsion means, an air cylinder connected to said pneumatic system, and a piston having a first end connected to the drawbar and a second end disposed within said pneumatic cylinder, said pneumatic system providing a drawbar flow of compressed air to said pneumatic cylinder for applying an outward force, directed generally away from said dolly, upon said piston and, thereby, said drawbar, for impeding collision between said dolly and the propulsion means.

14. The off-road dolly of claim 8, further comprising an electrical circuit connectable to a propulsion signal lighting system, situated on the propulsion means, having propulsion signal lights for indicating engagement of a propulsion braking means of the propulsion means and direction of the propulsion motion with respect to the propulsion means, and to a dolly signal lighting system, situated on said dolly, having dolly signal lights for indicating engagement of a dolly braking means on said dolly for further braking the propulsion motion and direction of the propulsion motion with respect to said dolly, each said propulsion means signal light corresponding to a corresponding dolly signal light, said electronic circuit providing synchronized operational engagement of said corresponding dolly signal light when said propulsion means signal light corresponding thereto is operatively engaged.

15. The off-road dolly of claim 8, wherein said dolly is connectable with said propulsion connecting means to a forklift, said forklift being the propulsion means.

16. The off-road dolly of claim 1, further comprising a motor and at least one propulsion wheel connected thereto for providing the propulsion motion, said motor being the propulsion means.

17. The off-road dolly of claim 16, wherein said at least one propulsion wheel comprises a plurality of wheels situated on generally opposed sides of the dolly extending between a first end and a second end thereof, said trailer connecting means being disposed on said second end, each said side having at least one said wheel, said at least one said wheel being situated in a generally central position thereon between said first and second end, said wheels providing a centrally situated dolly rotation axis generally centrally situated between said wheels and upon which said dolly rotates to change direction of the propulsion motion.

18. The off-road dolly of claim 16, wherein said remote control means comprises a remote transmitter having at least one braking control for engaging the trailer braking means and said dolly further comprises a receiver operatively connected to the pneumatic system which is operatively connected to the trailer braking means, said transmitter transmitting braking control signals when said braking control is manipulated by a user, said braking control signals being received by said receiver which operatively engages said pneumatic system for operatively engaging the trailer braking means.

19. The off-road dolly of claim 18, wherein said pneumatic system further comprises a pressure regulator valve disposed on a service air brake line of said pneumatic system operatively connected to a trailer service air brake of the trailer braking means, said pressure regulator valve adjusting said first air pressure level of a service brake flow of said compressed air flowing through said service brake line to operatively engage said trailer air service brake, said pressure valve being operatively connected to said receiver and being operatively engaged thereby in response to said braking control signals for adjusting said first air pressure level and thereby operatively engaging the trailer braking means.

20. The off-road dolly of claim 19, further comprising a dolly braking means having a dolly service air brake connected to said service brake line and responsive to said first air pressure level of said service brake flow, said dolly service brake being thereby synchronously and operationally engageable with said trailer service air brake by said pressure regulator valve, and thereby by said remote control means.
